(19) United States
(12) Patent Application Publication
(10) Pub. No.: US 2024/0377014 A1
(43) Pub. Date: Nov. 14, 2024

(54) SYSTEM AND METHOD FOR CONTROLLING A CAMERA OF A SEWER INSPECTION AND/OR MAINTENANCE SYSTEM

(71) Applicant: iPEK International GmbH, Sulzberg (DE)

(72) Inventors: Fabrizio TOZZO, Wolfertschwenden (DE); Rajeesh KUMAR, Kempten (DE); Muhammad TALHA, Durach (DE)

(21) Appl. No.: 18/658,599

(22) Filed: May 8, 2024

(30) Foreign Application Priority Data
May 9, 2023 (DE) 10 2023 112 061.1

(51) Int. Cl. F16L 55/48; F16L 55/34; F16L 55/40; F16L 101/30

(52) U.S. Cl. CPC F16L 55/48; F16L 55/34; F16L 55/40; F16L 2101/30

(57) ABSTRACT

A sewer inspection or maintenance system has an image recording device arranged on a crawler or pushing device by a joint system. The joint system is adapted to carry out pivot movements in at least two directions for pivoting the image recording device in a predetermined direction. An input device is adapted to receive a target point for a pivot movement of the joint system to be carried out, and a control device, which is coupled to the input device and to the joint system, and which is adapted to receive the target point received from the input device, to calculate joint angles of the joint system that correspond to the target point of the pivot movement to be carried out, and to determine control signals to transmit to the joint system, wherein the control signals cause the joint system to perform the pivot movement.

### CROSS REFERENCE TO RELATED APPLICATIONS

This application claims priority to German Patent Application No. 10 2023 112 061.1, filed May 9, 2023, the contents of which are incorporated by reference herein.

### FIELD OF THE INVENTION

The invention relates to a sewer inspection and/or maintenance system with an image recording device whose alignment can be controlled. The invention also relates to a method for aligning an image recording device of a sewer inspection and/or maintenance system.

### BACKGROUND OF THE INVENTION

In sewer inspection and/or maintenance systems, image recording devices (cameras or video cameras) are used to record the inside of a pipe or sewer. In the following, image recording device, camera and video camera are referred to collectively as “camera.” It may be necessary to align the viewing direction (optical axis) of the camera, for example to take a closer look at an area at the edge of the field of view or an area outside the camera's field of view.

In order to align a camera in any direction, joint systems can be provided, on which the camera can be arranged and which allow the camera to be pivoted in two directions (up/down or left/right). The joint systems can have corresponding servomotors.

To control the joint system or the alignment of the camera, it is known to provide so-called joysticks on a control panel, which is arranged outside the sewer or pipe and which is coupled to the sewer inspection and/or maintenance systems located in the sewer or pipe. Using the joystick, an operator of the system can control one of the two servomotors of the joint system, i.e., they can cause the joint system to pivot the camera either to the right/left or up/down. For example, in order to align the optical axis of the camera to the top right, the operator must initially control one servomotor in order to align the camera to the right and then control the other servomotor to align the camera upwards. It can indeed also cause the camera to move diagonally upwards to the right; however, this pivot movement is actually composed of multiple movements to the right and multiple movements upwards. In both cases, the operator must take into account the mechanical limits of the joint system and/or the limits of the servomotors in order to apply the correct joystick movement. This means that the operator must actively correct the servomotors of the joint system during the entire pivot movement from the starting point to the target direction or target point, which can take a lot of time and, in the worst case, can also lead to damage to the joint system.

### OBJECT OF THE INVENTION

Therefore, it is the object of the invention to provide solutions that enable a simpler and at the same time more rapid alignment of an image recording device of a sewer inspection and/or maintenance system.

### Solution According to the Invention

This object is achieved by a system and a method according to the independent claims. Advantageous embodiments are defined in the respective dependent claims.

Accordingly, a sewer inspection and/or maintenance system is provided, which comprises at least:
an image recording device, which is arranged via a joint system on a crawler or on a pushing device of the sewer inspection and/or maintenance system, wherein the joint system is adapted to carry out pivot movements in at least two directions in order to pivot the image recording device arranged thereon in a predetermined direction,
an input device, which is adapted to receive a target point for a pivot movement of the joint system to be carried out, and
a control device, which is coupled to the input device and to the joint system, and which is adapted,
to receive the target point received from the input device,
to calculate joint angles of the joint system that correspond to the target point of the pivot movement to be carried out, and
to determine control signals based on the current joint angles and on the calculated joint angles and to transmit these to the joint system, wherein the control signals cause the joint system to perform the pivot movement to be carried out up to the target point.

The image recording device can be a camera or a video camera.

As a result, the operator only has to enter a target point at the input device to which the optical axis of the image recording device is to be aligned. The joint angles of the joint system that correspond to the target point are automatically calculated by the control device. Based on these calculated joint angles and the current joint angles of the joint system, the control device determines control commands that cause the joint system to carry out a pivot movement from the current position to the target point. A particular advantage here is that the operator no longer has to carry out the pivot movement himself, but only has to define the target point of the pivot movement to be carried out. Active correction/adjustment of the joint system by the operator is completely eliminated and the target position or the desired alignment of the optical axis is achieved much more rapidly.

A pivot movement comprises both pivoting about a pivot axis and rotating about a rotation axis. Depending on the specific embodiment of the joint system, a combination of pivoting about a pivot axis and rotating about a rotation axis can also cause a pivoting of the optical axis of the image recording device towards the target point.

The joint system can comprise at least two servomotors, wherein a pivot movement in a first direction can be carried out with a first servomotor and a pivot movement in a second direction can be carried out with a second servomotor. Depending on the current alignment and the desired alignment of the optical axis, the control device determines control signals for both servomotors, wherein the control signals
cause the first servomotor of the joint system to perform the pivot movement in the first direction, and
cause the second servomotor of the joint system to perform the pivot movement in the second direction,

wherein the pivot movements in the first direction and in the second direction correspond to the pivot movement to be carried out up to the target point. After the completion/termination of the two pivot movements by the two servomotors, the optical axis of the image recording device is aligned in the desired direction, which has been defined by the target point.

It may be advantageous if the control signals cause the first servomotor and the second servomotor of the joint system to carry out the pivot movements in the first direction and in the second direction at least temporarily in parallel.

Thus, the duration of the pivot movement can be reduced even further, since the pivot movements up/down are carried out simultaneously by means of one servomotor and the pivot movement left/right by means of the other servomotor. As a result, the path of the pivot movement largely corresponds to the shortest distance between the current pivot position and the desired pivot position. The image of the image recording device displayed on a display device during the pivot movement thus appears harmonious, whereas the systems known from the prior art convey a jerky movement towards the target point.

The input device can comprise a touch-sensitive display device, such as a tablet, on which a two-dimensional frame is displayed, wherein the center of the frame corresponds to a neutral position of the joint system, and wherein each point within the frame corresponds to a target point for a pivot movement to be carried out.

The operator of the system only has to tap within the frame in order to define the desired target point for the pivot movement. The image provided by the image recording device can also be displayed together with the frame.

It may be advantageous here if a pivot position of the joint system in a first direction can be defined by the distance of the target point to the center of the frame and a pivot position of the joint system in a second direction can be defined by the angle of rotation of the target point in relation to the center of the frame. The operator can thus be assisted in defining the target point by tapping within the frame.

It may be advantageous if the input device is adapted to continuously receive target points and the control device is adapted to calculate joint angles of the joint system from the continuously received target points and to determine control signals based on the current joint angles and on the calculated joint angles and to transmit these to the joint system.

In each case, the user can define different target points several times in succession (in time), wherein the control device determines new control signals for this new target point and based on the current alignment of the joint system after each definition of a new target point.

In a particular embodiment of the invention, it can be provided that the input device detects a two-dimensional gesture (for example, a curve), wherein the control device can be adapted to determine the control signals such that they cause a pivoting of the joint system in such a way that the optical axis of the image recording device follows along the input gesture.

The control device can be adapted to take into account the mechanical limits of the joint system and/or the servomotors when determining the control signals.

Depending on the mechanical embodiment of the joint system, the pivot movement towards the target point can be determined accordingly.

A method for aligning an image recording device of a sewer inspection and/or maintenance system is also provided, wherein the image recording device is arranged via a joint system on a crawler or on a pushing device of the sewer inspection and/or maintenance system, wherein the joint system is adapted to carry out pivot movements in at least two directions in order to align the image recording device arranged thereon in a predetermined direction, wherein
a target point for a pivot movement of the joint system to be carried out is received via an input device,
a control device, which is coupled to the input device and to the joint system,
calculates joint angles of the joint system corresponding to the target point of the pivot movement to be carried out, and
based on the current joint angles and the calculated joint angles, control signals for the joint system are determined, wherein the determined control signals are used to cause the joint system to perform the pivot movement to be carried out up to the target point.

The joint system can comprise at least two servomotors, wherein based on the determined control signals
the first servomotor of the joint system carries out a pivot movement in a first direction, and
the second servomotor of the joint system carries out a pivot movement in a second direction, wherein the—combined-pivot movements in the first direction and in the second direction correspond to the pivot movement to be carried out up to the target point.

The first servomotor and the second servomotor can carry out their respective pivot movements in parallel, at least temporarily.

The input device can comprise a touch-sensitive display device, wherein a two-dimensional frame is displayed on the display device, wherein the center of the frame corresponds to a neutral position of the joint system, wherein each point within the frame corresponds to a target point for a pivot movement to be carried out, wherein a pivot position of the joint system in the first direction is defined by a distance of the target point from the center of the frame and a pivot position of the joint system in the second direction is defined by the angle of rotation of the target point in relation to the center of the frame.

The control device can continuously calculate joint angles of the joint system from continuously received target points and determine the control signals based on the current joint angles and the calculated joint angles.

### BRIEF DESCRIPTION OF THE FIGURES

Further details and features of the invention as well as specific, particularly advantageous exemplary embodiments of the invention are apparent from the following description in conjunction with the drawings. In the figures:

FIG. 1 shows an example of a joint system with an image recording device arranged thereon; and

FIG. 2 shows a block diagram of a system according to the invention; and

FIG. 3 shows an example of an input device for controlling the alignment of a joint system.

### DETAILED DESCRIPTION OF THE INVENTION

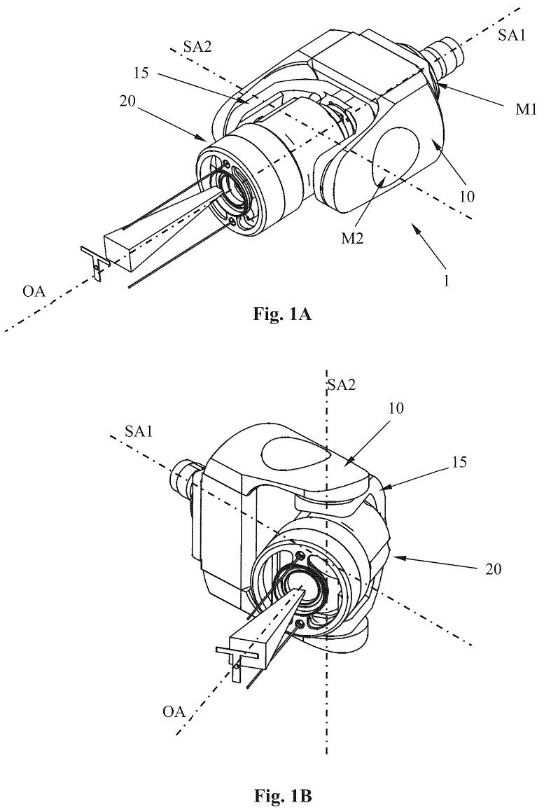

FIG. 1 shows an example of a joint system 1 with an image recording device 20 arranged thereon.

Figure (a) shows the joint system in a normal position, while Figure (b) shows the joint system in a pivoted position, which is different from the normal position.

The joint system 1 here comprises a first pivot fork 10, which can be fastened to an inspection crawler of a sewer inspection system, for example. The first pivot fork 10 is pivotable about a first pivot axis SA1, wherein, in the specific case shown here, the first pivot axis SA1 is designed as a pivot axis about which the first pivot fork 10 is rotatable through a specific angle, preferably through 360° in both directions.

A second pivot fork 15 is arranged in the first pivot fork 10, wherein the second pivot fork 15 can be pivoted about a second pivot axis SA2. In the example shown here, the second pivot fork 15 can be pivoted relative to the first pivot fork 10. The maximum pivot angle of the second pivot fork 15 is substantially limited by the first pivot fork 10. Preferably, the joint system is designed so that the second pivot fork 15 can be pivoted at least 90° in both directions from the normal position shown in Figure (a).

The second pivot fork 15 in turn accommodates a camera module 20 (image recording device), so that the camera module 20 can be pivoted together with the second pivot fork 15 relative to the first pivot fork 10. In addition, the camera module 20 together with the second pivot fork 15 can be pivoted or rotated about the first pivot axis SA1. This allows the optical axis OA of the camera module to be aligned in any direction. The camera module itself can be designed in such a way that it always provides an image in the correct position, regardless of the pivot position.

The first pivot fork 10 is assigned a first actuator M1, such as a servomotor, which is designed to pivot or rotate the first pivot fork 10 in a predetermined direction. The pivot path or the angle of rotation depends on the target point to which the optical axis OA of the camera module is to be aligned.

The second pivot fork 15 is assigned a second actuator M2, such as a servomotor, which is designed to pivot or rotate the second pivot fork 15 in a predetermined direction. The pivot path or the angle of rotation depends on the target point to which the optical axis OA of the camera module is to be aligned.

The joint system shown in FIG. 1 is only one possible example of an embodiment of the invention with which a camera or its optical axis can be pivoted. Other embodiments of the two pivot forks and the arrangement of the two pivot forks relative to one another are possible and are included in the solution according to the invention. According to the invention, it is merely important that a first unit (for example, the first pivot fork 10) of the joint system can be pivoted in two directions, and that a second unit (for example, the second pivot fork 15) of the joint system can also be pivoted in two directions, wherein the pivot axes of the two units are advantageously perpendicular to one another and wherein the pivoting or rotation of the two units is in each case effected by a controllable pivot means, such as a servomotor.

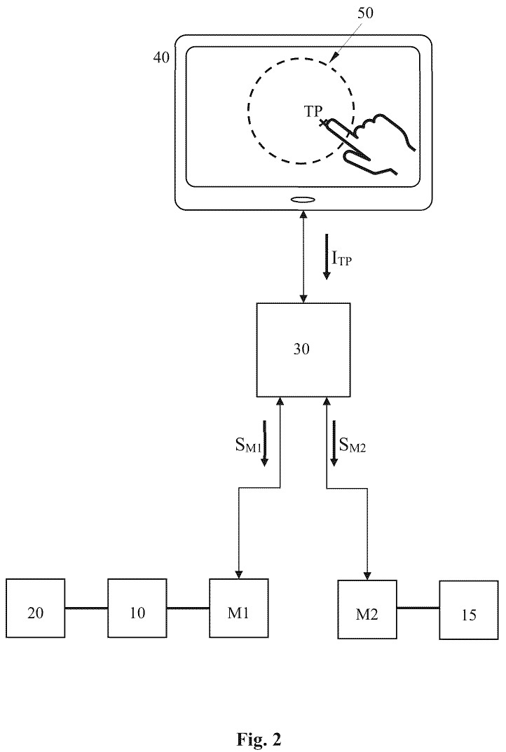

FIG. 2 shows a block diagram of a system according to the invention.

An operator of the system can enter a target point TP at an input device 40, which in this case is a tablet, for example by means of a touch gesture. The target point specifies the direction in which the optical axis OA of the camera module is to be aligned. A two-dimensional frame 50 can be displayed on the input device 40, which represents a simplified representation of the space within which the optical axis OA can be aligned.

The entered target point TP, i.e., information ITP about the entered target point TP, is transferred from the input device 40 to a control device 30. The control device 30 can be a component of the input device. However, it can also be designed as a separate unit.

The control device 30, which knows the current pivot position of the joint system and thus the current alignment of the optical axis OA, calculates joint angles (for the example shown in FIG. 1, a pivot angle for the first pivot fork and a pivot angle for the second pivot fork) for the joint system at which the target point TP lies on the optical axis OA of the camera system, i.e., the control device 30 calculates joint angles of the joint system that correspond to the target point of the pivot movement to be carried out.

Given that the control device 30 knows the current pivot position of the joint system and thus the current joint angles, it can determine control signals based on the current joint angles and on the calculated joint angles and transmit these to the joint system, wherein the control signals cause the joint system to perform the pivot movement to be carried out up to the target point.

In a specific embodiment, the control device 30 determines control signals S_{M1}, S_{M2} for the two actuating devices or servomotors M1, M2. The control signals S_{M1}, S_{M12} are used to control the servomotors in order to set the joint system to the calculated joint angle or to align the optical axis OA to the target point TP. The advantage here is that both servomotors can be operated simultaneously, so that the pivot movement to the target point can be executed much more rapidly and more precisely than by means of manual control of the servomotors, with which only one servomotor can usually be activated at a time. Since the path from the current alignment to the desired alignment (i.e., to the target point TP) is known, the servomotors can be operated in such a way that they describe an optimum acceleration curve. The image of the camera 20 displayed on a display device during the pivot movement of the joint system appears harmonious, i.e., a largely jerk-free image can be seen on the display device. The input device can also be designed as a display device. However, it is also possible for the input device and the display device to be separate units.

The servomotors M1, M2 are in each case coupled to a pivot fork or pivot unit. In the example of the invention shown in FIG. 1 and FIG. 2, the servomotor M1 is coupled to the first pivot fork 10 and the servomotor M2 is coupled to the second pivot fork 15, so that the servomotors can pivot the respective pivot fork in accordance with the control signals S_{M1}, S_{M12}.

The control device 30 and the servomotors M1, M2 are optionally also adapted so that the servomotors can transmit their respective position or setting to the control device. The respective position can be determined by means of appropriate sensors, for example.

The servomotors can be electric actuators, such as electric rotary and pivot drives.

The control signals S_{M1}, S_{M2} can contain information about the absolute position or alignment of the respective pivot fork to be set. As soon as the respective position is reached, the respective servomotor can be stopped.

In an alternative embodiment, the control device 30 can be designed such that it transmits control signals to the respective servomotor until the desired position or alignment is achieved. The control device in each case can query the respective current position from appropriately designed sensors.

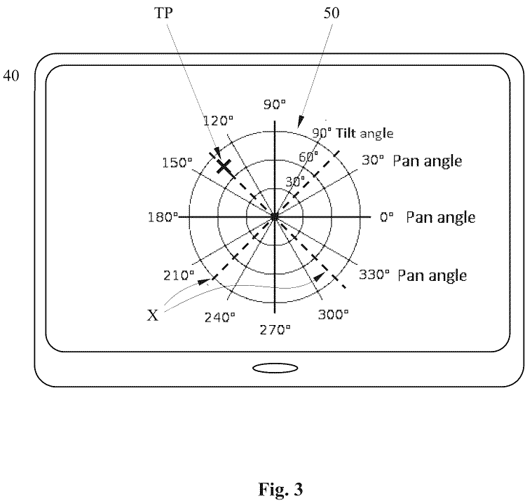

FIG. 3 shows a possible example of an input device for controlling the alignment of a joint system.

A two-dimensional frame 50 is displayed here on an input device 40, which substantially represents a simplified representation of the space within which the optical axis OA can be aligned. In the example shown here, the optical axis can be aligned anywhere within the outer circle, wherein the center of the coaxial circles can represent the neutral position of the joint system.

The frame 50 (also referred to as the input template) comprises a number (here 3) of concentric circles, and a number of straight lines running through the center point, which in each case are arranged at a predetermined angle to one another (here 12 lines, which in each case run at 30° to one another).

The straight lines here represent a first pivot angle (for example, of the first pivot fork 10), which can be between 0° and 360°. The concentric circles here represent a second pivot angle (for example, of the second pivot fork 15), which can be between 0° and 90°.

At the selected target point TP shown as an example in FIG. 3, the first pivot fork must be pivoted by approximately 135° from the normal position in accordance with the first pivot angle (represented by the straight lines). The second pivot fork must be pivoted by approximately 75° from the normal position according to the second pivot angle (represented by the concentric circles). After termination of the two pivot movements, which can be carried out simultaneously by the servomotor, the optical axis OA of the camera 20 is aligned so that it passes through the (virtual) target point TP or is aligned with the (virtual) target point TP.

The frame shown on the input device is only optional and serves primarily as an input aid. The control of the joint system can also be carried out at the input device or by means of the input device without such a frame. It is possible, for example, that a current image of the space in front of the camera is displayed on the input device and the operator defines the desired alignment of the optical axis based on this image, for example by means of a touch gesture on this image. However, it can be helpful to display the normal position of the joint system and/or the current alignment using corresponding symbols, for example as symbols that are superimposed on the displayed image. Information on the current pivot angles can also be displayed in a separate region on the input device.

A particular advantage of the invention is that an operator can select the desired 3D target direction (i.e., the target point TP) with the aid of a two-dimensional frame, which can also be represented by the current camera image. It may be advantageous (if necessary) to display an outer limiting frame that represents the maximum possible deflection of a pivot fork. If, for example, a pivot fork can only be deflected or pivoted by a maximum of 90°, it may be advantageous to show at least the outer circle in the example shown in FIG. 3. This prevents the operator from selecting pivot angles greater than 90°. Alternatively, such invalid entries can simply be ignored by the input device.

In one embodiment of the invention, the operator can also execute a two-dimensional gesture on the input device, for example by moving a finger over the input device. This gesture can represent a path that the optical axis of the camera is to follow. In this case, the control device is adapted to derive corresponding control instructions for the actuating devices or servomotors from the path and transmit them to the servomotors. Thus, special inspection scenarios can be mapped, for example an inspection of a sewer wall from top left to bottom left.

In FIG. 3, two lines X are shown in the frame, which run through the center point of the frame at a 45° angle. These two lines X represent rotation angles or pivot angles at which the alignment of the image recorded by the camera is changed if these angles are exceeded during the rotation or pivot movement, for example if a rotation movement of 40° is carried out in addition to a rotation position of 50°. This ensures that the image recorded by the camera is always displayed in the correct position, i.e., upright.

Thus, the invention makes it possible to align a camera in any direction with a simple gesture: up-down-left-right, without having to take into account the mechanical articulation limits of the connected camera.

A joint system on which the camera is mounted has been described above. A corresponding controllable joint system can also be arranged within a camera in order to align the optics of the camera accordingly.

1. A sewer inspection and/or maintenance system, comprising:
an image recording device, which is arranged via a joint system on a crawler or on a pushing device of the sewer inspection and/or maintenance system, wherein the joint system is adapted to carry out pivot movements in at least two directions in order to pivot the image recording device arranged thereon in a predetermined direction,
an input device, which is adapted to receive a target point for a pivot movement of the joint system to be carried out, and
a control device, which is coupled to the input device and to the joint system, and which is adapted,
to receive the target point received from the input device,
to calculate joint angles of the joint system that correspond to the target point of the pivot movement to be carried out, and
to determine control signals based on the current joint angles and on the calculated joint angles and to transmit these to the joint system, wherein the control signals cause the joint system to perform the pivot movement to be carried out up to the target point.

2. The system according to claim 1, wherein the joint system comprises at least two servomotors, wherein a pivot movement in a first direction can be carried out with a first servomotor and a pivot movement in a second direction can be carried out with a second servomotor.

5. The system according to claim 2, wherein the control signals:
cause the first servomotor of the joint system to perform the pivot movement in the first direction, and
cause the second servomotor of the joint system to perform the pivot movement in the second direction,
wherein the pivot movements in the first direction and in the second direction correspond to the pivot movement to be carried out up to the target point.

4. The system according to claim 3, wherein the control signals cause the first servomotor and the second servomotor of the joint system to carry out the pivot movements in the first direction and in the second direction at least temporarily in parallel.

5. The system according to claim 1, wherein the input device comprises a touch-sensitive display device, on which a two-dimensional frame is displayed, wherein the center of the frame corresponds to a neutral position of the joint system, wherein each point within the frame corresponds to a target point for a pivot movement to be carried out.

6. The system according to claim 5, wherein a pivot position of the joint system in a first direction can be defined by the distance of the target point to the center of the frame and a pivot position of the joint system in a second direction can be defined by the angle of rotation of the target point in relation to the center of the frame.

7. The system according to claim 1, wherein the input device is adapted to continuously receive target points and the control device is adapted to calculate joint angles of the joint system from the continuously received target points and to determine control signals based on the current joint angles and on the calculated joint angles and to transmit these to the joint system.

8. The system according to claim 2, wherein the control device is adapted to take into account the mechanical limits of the joint system and/or the servomotors when determining the control signals.

9. A method for aligning an image recording device of a sewer inspection and/or maintenance system, wherein the image recording device is arranged via a joint system on a crawler or on a pushing device of the sewer inspection and/or maintenance system, wherein the joint system is adapted to carry out pivot movements in at least two directions in order to align the image recording device arranged thereon in a predetermined direction, wherein:
a target point for a pivot movement of the joint system to be carried out is received via an input device,
a control device, which is coupled to the input device and to the joint system:
calculates joint angles of the joint system corresponding to the target point of the pivot movement to be carried out, and
based on the current joint angles and the calculated joint angles, control signals for the joint system are determined, wherein the determined control signals are used to cause the joint system to perform the pivot movement to be carried out up to the target point.

10. The method according to claim 9, wherein the joint system comprises at least two servomotors, wherein based on the determined control signals:
the first servomotor of the joint system carries out a pivot movement in a first direction, and
the second servomotor of the joint system carries out a pivot movement in a second direction,
wherein the pivot movements in the first direction and in the second direction correspond to the pivot movement to be carried out up to the target point.

11. The method according to claim 10, wherein the first servomotor and the second servomotor carry out their respective pivot movements in parallel, at least temporarily.

12. The method according to claim 9, wherein the input device comprises a touch-sensitive display device, wherein a two-dimensional frame is displayed on the display device, wherein the center of the frame corresponds to a neutral position of the joint system, wherein each point within the frame corresponds to a target point for a pivot movement to be carried out, wherein a pivot position of the joint system in the first direction is defined by a distance of the target point from the center of the frame and a pivot position of the joint system in the second direction is defined by the angle of rotation of the target point in relation to the center of the frame.

13. The method according to claim 9, wherein the control device calculates joint angles of the joint system from continuously received target points and determines the control signals based on the current joint angles and on the calculated joint angles.

14. The method according to claim 10, wherein the control device takes into account the mechanical limits of the joint system and/or the servomotors when determining the control signals.
